(19) United States
(12) Patent Application Publication
(10) Pub. No.: US 2007/0200847 A1
(43) Pub. Date: Aug. 30, 2007

(54) Method And Device For Controlling A Virtual Reality Graphic System Using Interactive Techniques

(75) Inventors: Andreas Rossler, Stuttgart (DE); Ralf Breining, Ostfildern (DE); Jan Wurster, Stuttgart (DE)

Correspondence Address: BROOKS KUSHMAN P.C., 1000 TOWN CENTER, TWENTY-SECOND FLOOR, SOUTHFIELD, MI, 48075, US

(73) Assignee: ICIDO GESELLSCHAFT FUR INNOVATIVE INFORMATIONSSYST, Stuttgart (DE)

(21) Appl. No.: 10/595,182

(22) PCT Filed: Sep. 16, 2004
(86) PCT No.: PCT/DE04/02077

§ 371 Date: Nov. 10, 2006

(30) Foreign Application Priority Data
Sep. 19, 2003 (DE) 103439684

(51) Int. Cl. G06T 15/00

(52) U.S. Cl. 345/419

(57) ABSTRACT

The invention relates to a method and a device for controlling a virtual reality (VR) graphic system using interactive techniques. Said VR graphic system comprises a projection device for visualising virtual three-dimensional scenes and the interaction with the VR graphic system takes place using at least one interactive device, which detects the respective position and/or orientation of the interactive device on a physical spatial trajectory, generates corresponding positional data and transmits said data to a position recorder of the VR graphic system. The invention is characterised in that an initial spatial point is defined on the physical spatial trajectory of the interactive device and that at least one subsequent interaction is evaluated in relation to the defined initial spatial point

The present invention generally relates to graphics systems for virtual reality (VR) applications and specifically relates to a method and an apparatus for controlling such a VR graphics system using interactions as claimed in the preambles of the respective independent claims.

A VR graphics system which is concerned in this case is evident from DE 101 25 075 A1, for example, and is used to generate and display a multiplicity of three-dimensional views which together represent a virtual three-dimensional scene. In this case, such a scene is usually correspondingly visualized using stereoscopic projection onto a screen or the like. So-called immersive VR systems which form an intuitive man-machine (user) interface for the various areas of use (FIG. 1) are already relatively widespread. Said graphics systems use a computer system to highly integrate the user into the visual simulation. This submersion of the user is referred to as “immersion” or an “immersive environment”.

As a result of the fact that three-dimensional data or objects are displayed to scale and as a result of the likewise three-dimensional ability to interact, these data or objects can be assessed and experienced far better than is possible with standard visualization and interaction techniques, for example with a 2D monitor and a correspondingly two-dimensional graphical user interface. A large number of physical real models and prototypes may thus be replaced with virtual prototypes in product development. A similar situation applies to planning tasks in the field of architecture, for example. Function prototypes may also be evaluated in a considerably more realistic manner in immersive environments than is possible with the standard methods.

Such a VR simulation is controlled in a computer-aided manner using suitable input units (referred to below, for the purpose of generalization, as “interaction units” since their function goes beyond pure data input) which, in addition to pushbuttons, have a position sensor which can be used to likewise continuously measure the spatial position and orientation of the interaction unit in order to carry out the interactions with the data which are displayed in the form of a scene (scene data). Such an interaction unit and a corresponding three-dimensional user interface are disclosed, for example, in DE 101 32 243 A1. The handheld cableless interaction unit described there is used to generate and transmit location, position and/or movement data (i.e. spatial position coordinates of the interaction unit) for the purpose of three-dimensional virtual navigation in said scene and in any functional elements of the user interface and for the purpose of manipulating virtual objects in the scene. To this end, the interaction unit has a sensor which interacts, via a radio connection, with a position detection sensor system provided in the VR graphics system. Said position data comprise the six possible degrees of freedom of translation and rotation of the interaction unit and are evaluated in real time in a computer-aided manner in order to determine a movement or spatial trajectory of the interaction unit.

User-guided interactions may, in principle, be subdivided into a logical part and a physical part. The logical part is the virtual three-dimensional user interface and includes, for example, the display of functions or menus, the method of selecting objects or function modes and the type of navigation. The physical part corresponds to the equipment-related implementation such as the technical configuration of the interaction unit and the projection technology used to display the scene.

As regards the use of said interaction units, it is desirable for said interactions, in particular more complex interactions such as function selection or menu control, to be as technically simple as possible and nevertheless to be capable of being controlled in a manner which is as safe as possible to use and is as operationally reliable as possible.

The invention therefore proposes a method and an apparatus for controlling a virtual reality (VR) graphics system (which is concerned in this case) using said interactions, which method and apparatus are based on the inventive concept of first of all forming a reference system, which is arranged on the spatial or movement trajectory of the interaction unit, and evaluating subsequent interactions using this reference system.

The special feature of the inventive method therefore resides in the fact that, as a result of a first interaction by the user, an initial spatial point which is initially fixed is determined, preferably together with an associated reference coordinate system, on the spatial trajectory of the interaction unit, and that the interaction unit is used to evaluate at least one subsequent interaction relative to the initial spatial point determined and the associated reference coordinate system.

Another refinement provides for the initial spatial point to represent the zero point or origin of said reference coordinate system and for reference or threshold values to be prescribed in this coordinate system, a particular function or a particular menu selection associated with the virtual user interface, which has been inserted into the current scene, being effected when said reference or threshold values are exceeded by the instantaneous spatial position or spatial orientation of the interaction unit. These reference values are preferably located on the surface of a geometric body which is arranged symmetrically (imaginary) with respect to the initial spatial point, for example on the surface of a sphere, the surface of an ellipsoid, the surface of a cube, the surface of a cuboid, the surface of a tetrahedron or the like. The reference points may also be weighted in particular spatial directions in order to assign different sensitivities to particular functions or menu selection items, during three-dimensional interaction, along the real spatial trajectory of the interaction unit, as a result of which incorrect operation or incorrect inputs by a user are avoided even more effectively.

Another refinement provides at least one further threshold value whose magnitude is greater than said at least one reference value, the reference coordinate system and the initial spatial point being caused to move to the new spatial position when said further threshold value is exceeded by the instantaneous spatial position of the interaction unit. This has the advantage that said advantageous method of operation of the reference coordinate system during said function or menu selection remains even in the case of (inadvertently) excessive changes in the position of the interaction unit.

The procedure proposed according to the invention and the user interface which is likewise proposed afford the advantage, in particular, that even complex interactions, for example over a plurality of function or menu levels, can be effected very intuitively, to be precise solely by means of spatial movement of the interaction unit. Only the determination of the first initial spatial point must be effected by means of a special interaction, preferably by means of a control element which is arranged on the interaction unit, for example a pushbutton or the like. In addition, control of the user interface by continuously evaluating said trajectory of the interaction unit becomes easier to handle and even more operationally reliable in comparison with the interaction systems which are known in the prior art.

Control of the VR graphics system using the interaction unit and a user interface that is visually inserted into the respective scene is preferably effected either via a function selection that is displayed in a three-dimensional visual manner or via a menu system such as the spherical menu described, for example, in DE 101 32 243 A1.

The invention can be used, with said advantages, in cableless and cable-bound interaction units which are preferably hand-guided by the user. It should be emphasized that, in addition to said use of the interaction unit including said control element (pushbutton), the possible interactions may also take place by means of acoustic or optical interactions, for example by means of voice, gestures or the like. In this case, use may be made of the input methods described in detail in the dissertation by A. RöBler entitled “Ein System für die Entwicklung von räumlichen Benutzungsschnittstellen” [A system for developing three-dimensional user interfaces], University of Stuttgart, published by Jost Jetter Verlag, Heimsheim, particularly on pages 72 ff. (chapters 4.3.2 ff.) thereof. In addition to the use of said interaction unit, the interaction modes described there such as direct and indirect and absolute and relative input may thus be additionally used to enable, for example, event-oriented interpretation of movements of the interaction unit or a part of the user's body.

In the case of said interpretation of the user's gestures, it is also possible to distinguish between static and dynamic gestures, the temporal sequence of a movement being analyzed in the case of dynamic gestures and a relative position or orientation between individual parts of the user's body, for example, being analyzed in the case of static gestures. In addition, it is possible to distinguish between simple input events and interpreted and combined input events, simple input events being triggered by discrete actions by the user, for example the operation of said pushbutton, whereas interpreted events are dynamically interpreted, for example taking into consideration a time measurement, for example when a button is pressed twice (“double click”). These two input modes may finally be combined in any desired manner, for example pressing a button once with a hand, head or facial gesture.

The inventive method and the apparatus are described below with reference to exemplary embodiments which are illustrated in the drawing and which reveal further features and advantages of the invention. In said exemplary embodiments, identical or functionally identical features are referenced using corresponding reference symbols.

### IN THE DRAWING

FIG. 1 shows a simplified overview of an immersive VR (virtual reality) graphics system which is concerned in this case;

FIGS. 2a-c show spatial trajectories, which typically result when an interaction unit as shown in FIG. 1 is physically moved in a three-dimensional manner, in order to illustrate the inventive procedure when evaluating these trajectories; and

FIG. 3 uses a flowchart to show the illustration of an inventive routine for controlling an interaction unit which is concerned in this case.

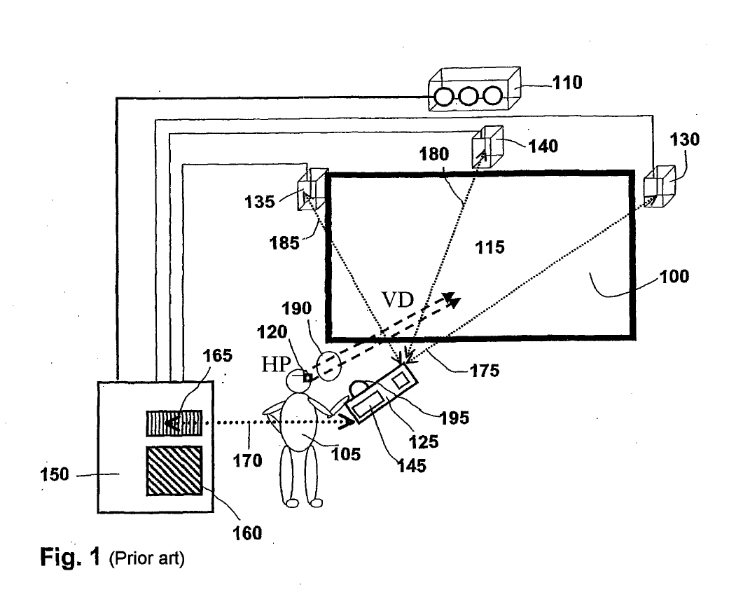

The VR graphics system which is diagrammatically illustrated in FIG. 1 has a projection screen 100 in front of which a person (user) 105 stands in order to view the scene 115, which is generated there via a projector 110, using stereoscopic glasses 120. It goes without saying that auto-stereoscopic screens or the like may also be used in the present case instead of the stereoscopic glasses 120. In addition, the projection screen 100, the projector 110 and the glasses 120 may be replaced in the present case with a data helmet which is known per se and then comprises all three functions.

The user 105 holds an interaction unit 125 in his hand in order to generate preferably absolute position data such as the spatial position and orientation of the interaction unit in the physical space and to transmit said data to a position detection sensor system 130-140. Alternatively, however, relative or differential position data may also be used but this is not important in the present context.

The interaction unit 125 comprises a position detection system 145, preferably an arrangement of optical measurement systems 145, both the absolute values of the three possible angles of rotation and the absolute values of the translational movements of the interaction unit 125, which are possible in the three possible spatial directions, being detected using said arrangement of measurement systems and being processed in real time by a digital computer 150 in the manner described below. Alternatively, these position data may be detected using acceleration sensors, gyroscopes or the like which then generally provide only relative or differential position data. Since this sensor system is not important in the present case, a more detailed description is dispensed with here and reference is made to the documents mentioned at the outset.

Said absolute position data are generated by a computer system which is connected to the interaction unit 125. To this end, they are transmitted to a microprocessor 160 of a digital computer 150 in which, inter alia, the necessary graphical evaluation processes (which are to be assumed to be familiar to a person skilled in the art) are carried out in order to generate the stereoscopic three-dimensional scene 115. The three-dimensional scene representation 115 is used, in particular, for visualizing object manipulations, for three-dimensional navigation in the entire scene and for displaying function selection structures and/or menu structures.

In the present exemplary embodiment, the interaction unit 125 is connected, for carrying data, to the digital computer 150, via a radio connection 170, using a reception part 165 (which is arranged there). The position data which are transmitted from the sensors 145 to the position detection sensor system 130-140 are likewise transmitted in a wireless manner by radio links 175-185.

Additionally depicted are the head position (HP) of the user 105 and his viewing direction (VD) 190 with respect to the projection screen 100 and the scene 115 projected there. These two variables are important for calculating a current stereoscopic projection insofar as they considerably concomitantly determine the necessary scene perspective since the perspective also depends, in a manner known per se, on these two variables.

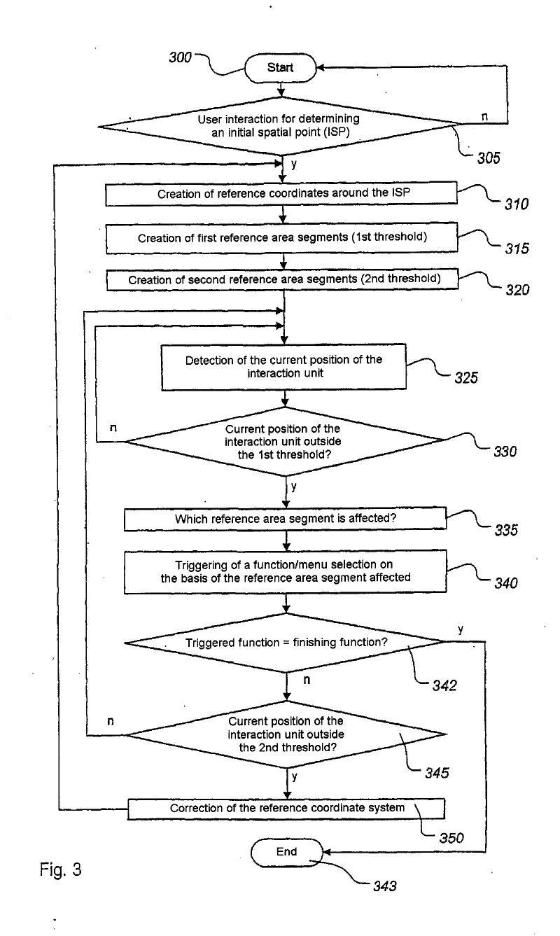

In the present exemplary embodiment, the interaction unit 125 comprises a pushbutton 195 which the user 105 can use, in addition to said possibilities for moving the interaction unit 125 in the space, to mechanically trigger an interaction, as described below with reference to FIG. 3. It goes without saying that two or more pushbuttons may also alternatively be arranged in order to enable different interactions, if appropriate.

The central element of the immersive VR graphics system shown is the stereoscopic representation (which is guided (tracked) using the position detection sensor system 130-140) of the respective three-dimensional scene data 115. In this case, the perspective of the scene representation depends on the observer's vantage point and on the head position (HP) and viewing direction (VD). To this end, the head position (HP) is continuously measured using a three-dimensional position measurement system (not illustrated here) and the geometry of the view volumes for both eyes is adapted according to these position values. This position measurement system comprises a similar sensor system to said position detection system 130-140 and may be integrated in the latter, if appropriate. A separate image from the respective perspective is calculated for each eye. The difference (disparity) gives rise to the stereoscopic perception of depth.

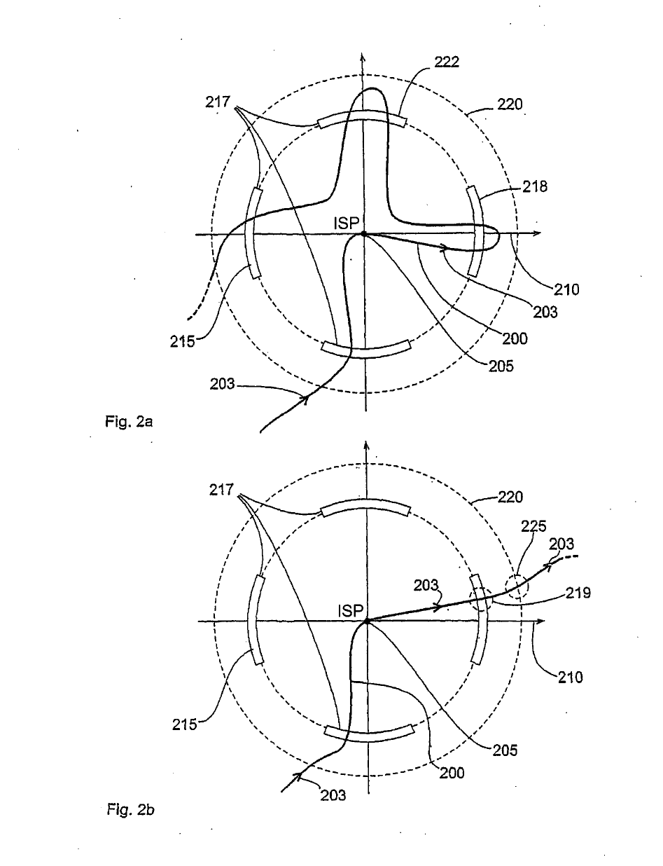

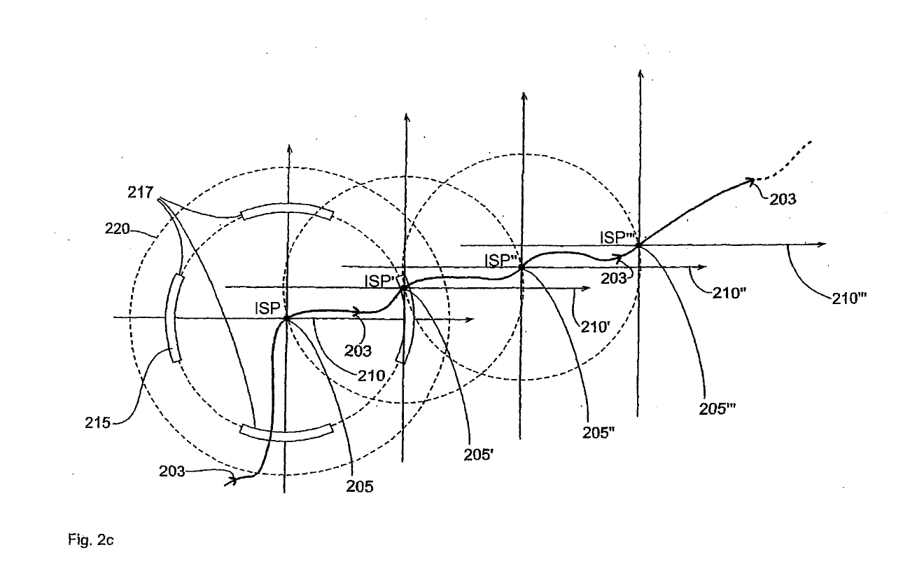

In the present case, an interaction by a user is understood as meaning any action by the user, preferably using said interaction unit 125. Included in this case are the movement of the interaction unit 125 on a spatial trajectory shown in FIGS. 2a-2c and the operation of one or more pushbuttons 195 which are arranged on the interaction unit 125. Acoustic actions by the user, for example a voice input, or an action determined by gestures may additionally be included.

FIGS. 2a-2c then illustrate typical spatial trajectories 200 which result when the above-described interaction unit 125 is moved. It should be emphasized that, for the purposes of simplification, FIGS. 2a-2c show only a two-dimensional section of the formation which is actually three-dimensional. In this case, spherical shells which are to be represented have been degenerated to lines, for example. The respective direction of movement along the course of the trajectory is indicated by arrows 203. It shall be assumed that the user 105 (not shown in this illustration) respectively uses the pushbutton 195, for example, at the point 205 and at the points 205′, 205″, 205′″ on the trajectory, to signal to the VR graphics system (FIG. 1) that an initial spatial point (ISP) 205 with an associated reference coordinate system 210 is to be determined. The spatial coordinates which correspond to the ISP and, as described above, are determined using the position detection sensor system 130-140 are transmitted to the digital computer 150 by radio in this case. From this time on, the further points on the trajectory 200 are calculated in relation to this ISP, virtually in new relative coordinates.

At the same time as the reference coordinate system 210 is determined, two shells which are arranged around the ISP 205 are calculated, to be precise an inner shell 215 having corresponding shell segments 217 and a continuous (i.e. not subdivided into such shell segments) outer shell 220. It should be emphasized that, in the technical sense, the shells shown represent only auxiliary means when calculating said threshold values and when calculating or detecting when these threshold values have been exceeded by the spatial trajectory of the interaction unit 125 and these shells therefore do not visually appear in the scene. The inner shell 215 defines the first threshold value mentioned at the outset, whereas the outer shell represents said second threshold value.

When penetrated by the trajectory 200, said shell segments 217 of the inner shell 215 are used to automatically trigger actions, preferably in a menu system of a user interface that is visualized in the present scene, to be precise actions such as opening a new menu item or selecting a function or a function mode from a multiplicity of functions or function modes offered. All known and conceivable manifestations, for example sphere-based or ellipsoid-based menus, cube-based or cuboid-based menus or flat transparent text menus, are suitable, in principle, as the menu system. The precise method of operation of such menu systems for selecting function modes or the like is described in detail in the two documents mentioned at the outset and these documents are therefore referred to in full in this respect in the present context.

The course of the trajectory shown in FIG. 2a corresponds to a scenario in which the user operates the pushbutton 195 while moving the interaction unit 125 in order to select a menu. In this case, operation of the pushbutton also causes a menu system to be visually inserted into the scene 115. The precise position of this insertion on the projection screen 100 is determined on the basis of the viewing direction (VD) 190 and/or the head position (HP) of the user 105. In this case, provision may be made for the viewing direction (VD) and/or the head position (HP) to be detected continuously or occasionally and for the precise position at which the menu system or the function selection system is inserted to be determined on the basis of the viewing direction (VD) detected and/or the head position (HP) detected.

For reasons of symmetry (spherical symmetry of the above-described shells), the present exemplary embodiment is likewise preferably a spherical symmetrical menu system, for example a spherical menu. It goes without saying that the spherical shells shown in FIGS. 2a-2c are only exemplary and may also be formed by cube-shaped, cuboidal or ellipsoidal shells. Cubic symmetrical shell shapes, for example, are thus suitable in menu systems which are likewise cubic symmetrical (cube-shaped, cuboidal or in the form of text).

The trajectory 200 shown in FIG. 2a penetrates the inner shell 215 for the first time in the region of a first spherical shell segment 218. This triggers a first menu or function selection. The trajectory 200 then enters the inner region of the shell 215 again at the level of this segment 218 in order to penetrate said shell 215 again at the level of a second spherical shell segment 222 and thus trigger a further function selection. The further course (indicated by dots) of the trajectory 200 is no longer important in the present case.

It goes without saying that, in the simplest refinement, the threshold value areas shown in FIGS. 2a-2c may also be formed by scalar threshold values, for example in the case of a cubic reference coordinate system instead of the spherical coordinate system shown here, only a single scalar threshold value having to be determined in each of the three spatial directions.

FIG. 2b illustrates the course of a trajectory in which, after the ISP 205 has been determined, the trajectory 200 first of all penetrates the inner shell 215 in the region of a spherical shell segment 219, as a result of which a function selection or the like is again triggered. In contrast to FIG. 2a, the trajectory then also penetrates the outer shell, to be precise at the point 225 shown. This penetration of the outer shell gives rise to the automatic correction (already mentioned) of the reference coordinate system 210, the ISP 205 being shifted to said penetration point, i.e. to the point 225 in the present case, in the present exemplary embodiment.

In an alternative refinement, the ISP follows the trajectory incrementally (i.e. in incremental steps or virtually gradually), either the outer shell being degenerated to a shell with a smaller diameter than the inner shell or the ISP respectively following the continuing trajectory incrementally as of said penetration point 225. As already said, the outer shell does not have any segmentation since it is not intended to trigger any use-specific events but merely said correction of the entire reference coordinate system 210.

FIG. 2c is finally intended to be used to illustrate what happens when the interaction unit 125 is moved over a relatively long distance, after an ISP 205 has already been determined, for example owing to the fact that the user is moving over a relatively long distance in front of the projection screen 100 after a menu system has already been activated. As follows from the above description, repeatedly leaving the outer shell 220 gives rise to repeated correction (three times in the present exemplary embodiment) of the ISP 205, respectively resulting in ISPs 205′, 205″ and 205′″, and of the reference coordinate system 210 associated with said ISP, respectively resulting in reference coordinate systems 210′, 210″ and 210′″ which have been correspondingly shifted and are illustrated using dashed lines in the present case.

It should be noted that, for the purpose of generalization, the physical spatial trajectory shown in FIGS. 2a-2c may be represented either by a pure translational movement or a pure rotational movement of the interaction unit 125 or else by a combination of these two types of movement. In the case of such rotational movements of the interaction unit in order to trigger particular interactions with an above-described menu system or in order to manipulate virtual objects in the scene 115, provision may additionally be made for the interaction to be triggered only when at least one second interaction, in particular using the control element, has been triggered. This advantageously prevents even a slight rotation (which may be undesirable) of the interaction unit 125 triggering an interaction. It is also possible for rotations of the interaction unit 125 to be canceled again without even having to trigger an interaction in the VR graphics system.

FIG. 3 now shows an exemplary embodiment of an inventive routine for evaluating the spatial course of a trajectory which has been assumed as in FIGS. 2a-2c. After the start 300 of the routine, which is preferably triggered by switching on the VR graphics system or by, for instance, subsequently activating the interaction unit 125, the routine is first of all in a waiting loop in which a check is continuously or occasionally carried out 305 in order to determine whether the user has carried out an interaction in order to determine, if appropriate, an above-described initial spatial point ISP 205 at the instantaneous spatial position of the interaction unit. This “initial” interaction is preferably effected using the above-described pushbutton 195 but may also be effected in the manner described at the outset by means of voice, gestures or the like.

If such an initial interaction is determined, said reference coordinate system 210 is first of all determined in step 310, the coordinate origin being formed by the ISP 205. In subsequent steps 315 and 320, the reference points or reference area segments 217 of said first threshold 215 and the second threshold area 220 are determined in the reference coordinate system 210.

Said steps are again followed by a loop in which the current position of the interaction unit 125 is first of all detected 325. A check is then carried out 330 in order to determine whether the detected value of the current position is outside said first threshold value or the value of the present reference area segment 217. If this condition 330 is not satisfied, the routine jumps back to step 325 in order to detect a new current position value of the interaction unit 125. However, if the condition 330 is satisfied, the trajectory has penetrated the first threshold area 215. In this case, a check is also first of all carried out 335 in order to determine which reference point or which reference area segment in the reference coordinate system is affected thereby. The corresponding function or menu selection is then triggered 340 on the basis of the result of the last check 335.

In the special case of the triggered function being a function that ends the entire routine, which is additionally checked in step 342, the process jumps to step 343 in which the routine is then ended.

In the case of the trajectory actually having penetrated the first threshold area 215, a check is also carried out 345 in order to determine whether the trajectory has also already penetrated the second threshold area 220. That is to say a check is also carried out 345 in this case in order to determine whether the magnitude of the value of the current position of the interaction unit 125 in the present reference coordinates exceeds the value of the second threshold. If this condition is not satisfied, the process jumps back to step 325 again and a new position value of the interaction unit 125 is detected. Otherwise, the reference coordinate system and its origin 350 which coincides with the ISP 205 are corrected and, if appropriate, incrementally shifted to the current position of the trajectory of the interaction unit 125.

It should finally be noted that the above-described concept of the initial spatial point (ISP) also includes, in principle, user interfaces in which the interaction is effected using a pure rotation of the interaction unit 125 or a combination of a pure translation and a pure rotation. In the case of a rotation, the ISP can be understood as meaning an initial spatial angle φ=0° of an imaginary spherical or cylindrical coordinate system. In this case, the two threshold values described may be formed by discrete angles, for example φ=90° and φ=180°, said coordinate system then being corrected, for example, by the angle φ=180° when the threshold values are exceeded by φ=180°.

1. A method for controlling a virtual reality (VR) graphics system using interactions, the VR graphics system having a projection device for visualizing virtual three-dimensional scenes and the interactions with the VR graphics system taking place using at least one interaction unit, which is used to detect the respective position and/or orientation of the interaction unit on a physical spatial trajectory and to generate corresponding position data and to transmit these position data to a position detection device of the VR graphics system, characterized in that an initial spatial point on the physical spatial trajectory of the interaction unit is determined, and in that at least one subsequent interaction is evaluated relative to the initial spatial point determined.

2. The method as claimed in claim 1, characterized in that reference coordinates are determined using the initial spatial point, the at least one subsequent interaction being evaluated relative to these reference coordinates.

3-16. (canceled)

17. The method as claimed in claim 1, characterized in that at least one threshold value or a first threshold value area is formed using the initial spatial point and/or the reference coordinates, at least one action or function of the VR graphics system being triggered when said threshold value or threshold value area is exceeded by the physical spatial trajectory.

18. The method as claimed in claim 17, characterized in that the first threshold value area defines at least two different threshold values which are used for weighting when the at least one action or function of the VR graphics system is triggered.

19. The method as claimed in claim 17, characterized in that the first threshold value area is formed by a symmetrical three-dimensional body, in particular a sphere, an ellipsoid, a cube, a cuboid or the like.

20. The method as claimed in claim 1, characterized in that the initial spatial point and/or the reference coordinates is/are used to form at least one second threshold value area whose value is essentially greater than the value of the first threshold value area, shifting of the zero point of the reference coordinates in the direction of the spatial trajectory being triggered when said second threshold value area is exceeded by the physical spatial trajectory.

21. The method as claimed in claim 1, characterized in that the initial spatial point is determined using a first interaction.

22. The method as claimed in claim 21, characterized in that the first interaction takes place using the interaction unit, in particular using a control element which is arranged on the interaction unit, or using a user's acoustic, linguistic or gesticulatory interaction.

23. The method as claimed in claim 1 for use in a VR graphics system having at least one three-dimensional virtual menu system or function selection system, characterized in that the at least one subsequent interaction is used to control the menu system or the function selection system.

24. The method as claimed in claim 23, characterized in that, on account of the first interaction, the menu system or the function selection system is inserted into the virtual scene, with regard to the projection device, on the basis of the viewing direction and/or the head position of a user who is holding the interaction unit, in that the viewing direction and/or the head position is/are detected continuously or occasionally, and in that the position on the projection device, at which the menu system or the function selection system is/are inserted, is determined on the basis of the viewing direction detected and/or the head position detected.

25. The method as claimed in claim 23, characterized in that an action or function which is to be effected by means of a rotational movement of the interaction unit is triggered only when at least one second interaction is carried out, in particular using the control element.

26. A three-dimensional user interface for controlling a virtual reality (VR) graphics system using interactions, the VR graphics system having a projection device for visualizing virtual three-dimensional scenes and the interactions with the VR graphics system taking place using at least one interaction unit, which is used to detect the respective position and/or orientation of the interaction unit on a physical spatial trajectory and to generate corresponding position data and to transmit these position data to a position detection device of the VR graphics system, characterized by means for generating an initial spatial point on the physical spatial trajectory of the interaction unit and for evaluating at least one subsequent interaction relative to the initial spatial point determined.

27. The user interface as claimed in claim 26, characterized by means for calculating virtual reference coordinates on the basis of the initial spatial point and for evaluating the at least one subsequent interaction relative to these reference coordinates.

28. The user interface as claimed in claim 27, characterized by means for calculating at least one threshold value or a first threshold value area on the basis of the reference coordinates and means for triggering an action or function of the VR graphics system when the threshold value or the first threshold value area is exceeded by the physical spatial trajectory.

29. The user interface as claimed in claim 26, characterized by means for calculating at least one second threshold value area on the basis of the reference coordinates, the value of said second threshold value area essentially greater than the value of the first threshold value area, and means for shifting the zero point of the reference coordinates in the direction of the spatial trajectory when the second threshold value area is exceeded by the physical spatial trajectory.

30. A virtual reality (VR) graphics system which operates according to the method of claim 1.

31. A virtual reality (VR) graphics system which has a user interface as claimed in claim 26.
